(19) United States
(12) Patent Application Publication
(10) Pub. No.: US 2022/0255751 A1
(43) Pub. Date: Aug. 11, 2022

(54) SYSTEM AND METHOD CAPABLE OF UPLOADING DATA INTO BLOCKCHAIN

(71) Applicant: INNODISK CORPORATION, New Taipei City (TW)

(72) Inventors: CHIN-CHUNG KUO, New Taipei City (TW); MING-SHENG CHEN, New Taipei City (TW)

(21) Appl. No.: 17/648,265

(22) Filed: Jan. 18, 2022

(30) Foreign Application Priority Data
Feb. 8, 2021 (TW) 110104781

(51) Int. Cl. H04L 9/32

(52) U.S. Cl. CPC H04L 9/3239; H04L 2209/38

(57) ABSTRACT

The invention provides a system capable uploading data into a blockchain, which comprises a data storage device and an electronic device. The data storage device comprises a controller, a plurality of flash memories, and a data transmission interface. The electronic device comprises a processor and a network communication component. The controller calculates a specific data stored in the flash memories by a hash algorithm to obtain a hash data corresponding to the specific data, and transmits the hash data to the electronic device. The processor of the electronic device uploads the hash data to the blockchain by a data chaining program so as to chain the hash data into the blockchain. Accordingly, the system chains the hash data corresponding to the specific data into the blockchain to ensure the security of the specific data in use.

This non-provisional application claims priority claim under 35 U.S.C. § 119(a) on Taiwan Patent Application No. 110104781 filed Feb. 8, 2021, the entire contents of which are incorporated herein by reference.

### FIELD OF THE INVENTION

The present invention relates to a data chaining system, more particularly, to a data chaining system capable of uploading data to a blockchain, and chaining data into the blockchain.

### BACKGROUND

With the need for data storage, a data storage data, for example, solid state drive (SSD), often used by a computer host or an automatic device to store important data. Besides, the current Internet is flooded with malicious hackers. In order to achieve a specific purpose, some malicious hackers often invade the computer hosts of some government units or companies, and tamper with the data stored in the data storage devices of these computer hosts.

When the tampered data in the data storage device is an important commercial data (such as financial data, customer data, etc.), it will arise many problems if the tampered data is able to be not identified, and further used in transactions or personal information.

### SUMMARY

It is one objective of the present invention to provide a data chaining system, which comprises a data storage device and an electronic device that is able to be connected to Internet. The electronic device may chain a data stored in the data storage device into a blockchain in cloud so that the data of the data storage device can be protected in the blockchain based on the characteristics of the blockchain data that cannot be tampered with and forged.

It is other objective of the present invention to provide a data chaining system, wherein the data storage device comprises a controller, a plurality of flash memories, and a data transmission interface, and the electronic device comprises a processor and a network communication component. The controller calculates a specific data in the flash memories by a hash algorithm to obtain a first hash data corresponding to the specific data, and transmits the first hash data to the electronic device via the data transmission interface. The processor of the electronic device uploads the first hash data to the blockchain by a data chaining program so as to chain the first hash data into the blockchain. Afterwards, when the user desires to use the specific data stored in the flash memories, the controller calculates the current specific data in the flash memories by the hash algorithm again to obtain a second hash data corresponding to the current specific data, and transmits the second hash data to the electronic device via the data transmission interface. The processor of the electronic device downloads the first hash data from the blockchain via the network communication component, and compares whether the second hash data is equal to the first hash data such that the authenticity of the specific data can be determined based on the comparison result. Accordingly, through the characteristics of blockchain data that cannot be tampered with and cannot be forged, the security of the data of the data storage device in use can be ensured.

To achieve the above objective, the present invention provides a system capable of uploading data into a blockchain, the system comprising: a data storage device comprising: a data transmission interface; a controller; and a plurality of flash memories, wherein the controller is connected to the data transmission interface and the flash memories, and calculates a specific data to be stored to the flash memories or the specific data stored in the flash memories by a hash algorithm to obtain a first hash data corresponding to the specific data; and an electronic device, comprising: a processor; and a network communication component, wherein the processor is connected to the network communication component, the electronic device is network connected to a blockchain via the network communication component; wherein the data storage device transmits the first hash data to the electronic device via the data transmission interface, when the electronic device receives the first hash data, the processor of the electronic device executes a data chaining program, and uploads the first hashed data to the blockchain by the data chaining program so as to chain the first hash data into the blockchain.

In one embodiment of the present invention, wherein the flash memories are formed with a first data storage area and a second data storage area, the first data storage area is used for storing general data, the second data storage area is used for storing the specific data.

In one embodiment of the present invention, wherein the specific data is a data in a specific file format, or a data with a specific content.

In one embodiment of the present invention, wherein the controller comprises a firmware, and the data chaining program is disposed in the firmware.

In one embodiment of the present invention, wherein the processor is configured with an embedded system, and the data chaining program is installed in the embedded system.

In one embodiment of the present invention, wherein the electronic device receives the specific data from the data storage device, and uploads the specific data to the blockchain by the data chaining program so as to chain the specific data into the blockchain.

In one embodiment of the present invention, wherein the data transmission interface is SATA transmission interface, PCIe transmission interface, or USB transmission interface.

The present invention further provides a method capable of uploading data into a blockchain, which is adapted to a data chaining system, wherein the data chaining system comprises a data storage device and an electronic device; the data storage device comprises a controller, a plurality of flash memories, and a data transmission interface; the electronic device comprises a processor and a network communication component; the data storage device and the electronic device are connected together via the data transmission interface, and the electronic device is network connected to a blockchain via the network communication component, the method comprising: calculating a specific data to be stored to the flash memories or the specific data stored in the flash memories by a hash algorithm executed by the controller of the data storage device to obtain a first hash data; transmitting the first hash data to the electronic device via the data transmission interface of the data storage device; and executing a data chaining program by the microprocessor of the data storage device to upload and chain the first hash data into the blockchain.

In one embodiment of the present invention, further comprising: uploading the specific data to the blockchain by the data chaining program to chain the specific data into the blockchain.

In one embodiment of the present invention, further comprising a data authenticity verification procedure comprising: calculating the specific data in the flash memories again by the hash algorithm executed by the controller of the data storage device to obtain a second hash data; transmitting the second hash data to the electronic device by the data transmission interface of the data storage device; downloading the first hash data corresponding to the specific data from the blockchain by the processor of the electronic device via the network communication component; and comparing whether the second hash data is equal to the first hash data to determine whether the specific data is tampered with.

### BRIEF DESCRIPTION OF THE DRAWINGS

FIG. 1 is a structural view of a data chaining system of the present invention.

FIG. 2 is a flow chart of a method capable of uploading data into a blockchain of the present invention.

### DETAILED DESCRIPTION OF THE PREFERRED EMBODIMENTS

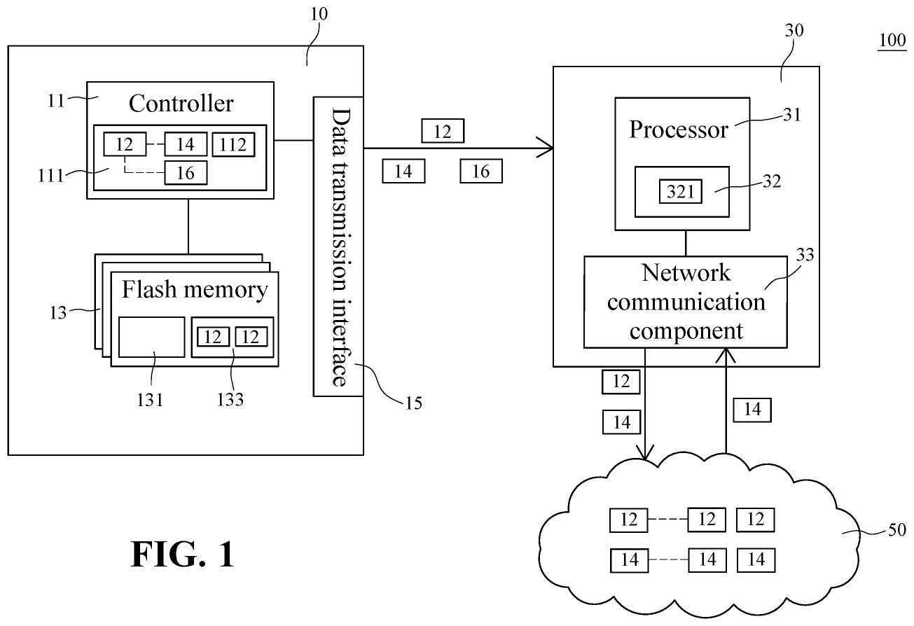

Referring to FIG. 1, there is shown a structural view of a data chaining system of the present invention. As shown in FIG. 1, the data chaining system 100 comprises a data storage device 10 and an electronic device 30. The data storage device 10 may be a solid state disk (SSD). The data storage device 10 comprises a controller 11, a plurality of flash memories 13, and a data transmission interface 15. The controller 11 is connected to the flash memories 13, and a data transmission interface 15. The data transmission interface 15 is SATA transmission interface, PCIe transmission interface, or USB transmission interface. The controller 11 comprises a firmware 111. Besides, the data storage device 10 further comprises a hash algorithm 112. In one embodiment of the present invention, the hash algorithm 112 is configured in the firmware 111 of the controller 11, and executed by the controller 11. Alternatively, the flash memories 13 of the data storage device 10 is installed with an operating system, the hash algorithm 112 is installed in the operating system in a form of software, and is executed by the operating system.

The electronic device 30 comprises a processor 31 and a network communication component 33. The processor 31 is connected to the network communication component 33. The network communication component 33 is a WiFi communication component, an RJ45 communication component, or a 3G, 4G or 5G communication component. The electronic device 30 is connected to a blockchain 50. The processor 31 is configured with an embedded system 32 that is an architecture system of Linux, RTOS, or TinyOS, and stored in non-volatile memories (NVMs). In another embodiment of the present invention, a data chaining program 321 is installed in the embedded system 32 of the microprocessor 31 in a form of software, and executed by the embedded system 32.

A specific data 12, for example, commercial data, confidential data, personal data or data in a specific format, etc., can be stored into the flash memories 13 via the data transmission interface 15 of the data storage device 10. In one embodiment of the present invention, the controller 11 executes the hash algorithm 112 in advance before the specific data 12 is to be stored in the flash memories 13. Then, the controller 11 calculates the specific data 12 by the hash algorithm 112 to obtain a first hash data 14 corresponding to the specific data 12, and transmit the first hash data 14 to the electronic device 30 via the data transmission interface 15.

After the electronic device 30 receives the first hash data 14, the processor 31 of the electronic device 30 executes the data chaining program 321 to upload the first hash data 14 to the blockchain 50, and therefore chain the first hash data 14 into the blockchain 50 by the data chaining program 321. Accordingly, through the characteristics of blockchain data that cannot be tampered with and cannot be forged, the first hash data 14 can be protected in the blockchain 50. After the first hash data 14 is chained in the blockchain 50, the controller 11 writes the specific data 12 into the flash memories 13.

In other embodiment of the present invention, data sectors of the flash memories 113 are formed with a first data storage area 131 and a second data storage area 133. The first data storage area 131 is used for storing general data, for example, operating system or application program. The second data storage area 133 is used for storing the specific data 12, for example, business document, license document, or confidential document. When the specific data 12 has been stored in the second data storage area 133, the controller 11 will automatic execute the hash algorithm 112 to calculates each specific data 12 in the second data storage area 133 by the hash algorithm 112 to obtain each first hash data 14 corresponding to each specific data 12, respectively; then, the controller 11 transmits each first hash data 14 corresponding to each specific data 12 to the electronic device 30 via the data transmission interface 15. The electronic device 30 successively receives each first hash data 14 corresponding to each specific data 12, and uploads each first hash data 14 corresponding to each specific data 12 to the blockchain 50 respectively to chain each first hash data 14 corresponding to each specific data 12 into the blockchain 50 respectively. Through the characteristics of blockchain data that cannot be tampered with and cannot be forged, each first hash data 14 corresponding to each specific data 12 will be protected in the blockchain 50.

In another embodiment of the present invention, the specific data 12 is a data in a specific file format of, for example, data in WORD file format, PDF file format, PPT file format, JPG file format, EXCEL file format, DWG file format, or other file format. When the controller 11 knows that the data 12 in the specific file format is to be stored to the flash memories 13, or has stored in the flash memories 13 according to the analyzation of the file extension of the data 12, the hash algorithm 112 will be automatically executed by the controller 11. The controller 11 calculates the data 12 in the specific file format by the hash algorithm 112 to obtain the first hash data 14 corresponding to the data 12 in the specific file format, and then transmits the first hash data 14 corresponding to the data 12 in the specific file format to the electronic device 30. Afterwards, the electronic device 30 uploads the first hash data 14 corresponding to the data 12 in the specific file format to the blockchain 50 by the data chaining program 321 so as to chain the first hash data 14 corresponding to the data 12 in the specific file format into the blockchain 50. Through the characteristics of blockchain data that cannot be tampered with and cannot be forged, the first hash data 14 corresponding to the data 12 in the specific file format will be protected in the blockchain 50.

In yet another embodiment of the present invention, the specific data 12 is a data with a specific content, for example, business contract data, license document data or basic personal data. When the controller 11 knows that the data 12 with the specific content is to be stored to the flash memories 13, or has stored in the flash memories 13 by analyzing the content of the data 12 according to one or more key words, the hash algorithm 112 will be automatically executed by the controller 11. The controller 11 calculates the data 12 with the specific content by the hash algorithm 112 to obtain the first hash data 14 corresponding to the data 12 with the specific content, and then transmits the first hash data 14 corresponding to the data 12 with the specific content to the electronic device 30. Afterwards, the electronic device 30 uploads the first hash data 14 corresponding to the data 12 with the specific content to the blockchain 50 by the data chaining program 321 so as to chain the first hash data 14 corresponding to the data 12 with the specific content into the blockchain 50. Through the characteristics of blockchain data that cannot be tampered with and cannot be forged, the first hash data 14 corresponding to the data 12 with the specific content will be protected in the blockchain 50.

Before the specific data 12 stored in the flash memory 13 wants to be used as a proof, a transaction or other specific requirements, the data chaining system 100 will execute a data authenticity verification procedure. In the data authenticity verification procedure, the controller 11 of the data storage device 10 calculates the current specific data 12 in the flash memories 13 by the hash algorithm 112 again to obtain a second hash data 16, and transmits the second hash data 16 to the electronic device 30. After the processor 31 of the electronic device 30 receives the second hash data 16, the data chaining program 321 downloads the first hash data 14 corresponding to the specific data 12 from the blockchain 15 via the network communication component 33, and then compares whether the second hash data 16 is equal to the first hash data 14. If the data chaining program 321 determines that the second hash data 16 is equal to the first hash data 14, the specific data 12 is an original data that does not tampered with. On the contrary, if the data chaining program 321 determines that the second hash data 16 is not equal to the first hash data 14, the specific data 12 is a data tampered with.

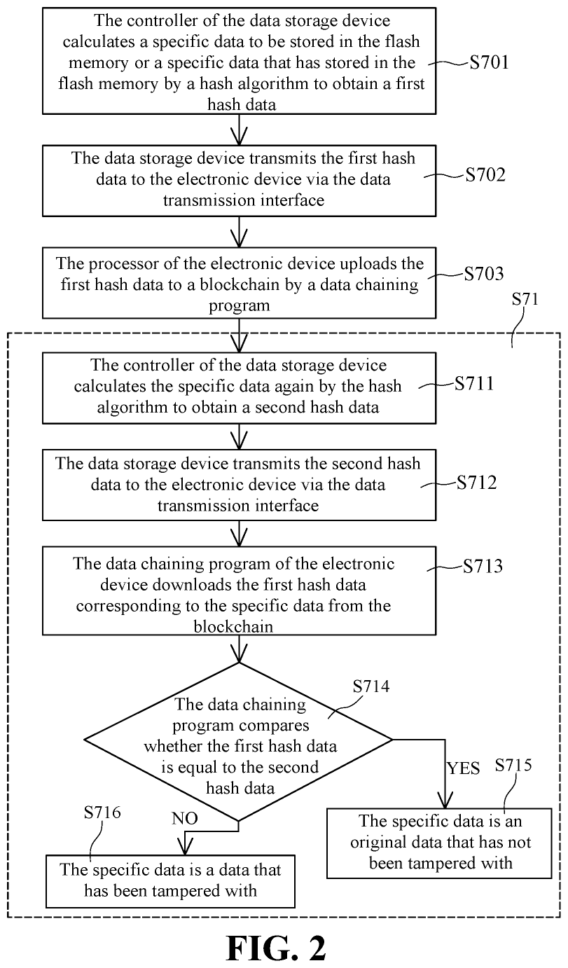

Referring to FIG. 2, there is shown a flow chart of a method capable of uploading data into blockchain of the present invention. As shown in FIG. 2, firstly, in Step S701, the controller 11 of the data storage device 10 calculates a specific data 12 to be stored to the flash memories 13 or a specific data 12 stored in the flash memories 13 by a hash algorithm to obtain the first hash data 14. In Step S702, the data storage device 10 transmits the first hash data 14 to the electronic device 30 via the data transmission interface 15. In Step S703, after the electronic device 30 receives the first hash data 14, the processor 31 uploads the first hash data 14 to the blockchain 50 by the data chaining program 321 so as to chain the first hash data 14 into the blockchain 50. In one embodiment of the present invention, the electronic device 30 can also receive the specific data 12 from the data storage device 10, and upload the specific data 12 and the first hash data 14 corresponding to the specific data 12 at the same time to the blockchain 50.

Afterwards, a data authenticity verification procedure S71 will be executed by the data chaining system 100 before the user wants to use the specific data 12 in the flash memory 13. In the Step S711 of the data authenticity verification procedure S71, the controller 11 of the data storage device 10 calculates the current specific data 12 in the flash memories 13 by the hash algorithm 112 again to obtain a second hash data 16. In the Step S712, the data storage device 10 transmits the second hash data 16 to the electronic device 30 via the data transmission interface 15. In the Step S713, after the processor 31 of the electronic device 30 receives the second hash data 16, the data chaining program 321 downloads the first hash data 14 corresponding to the specific data 12 from the blockchain 15 via the network communication component 33. In the Step S714, the data chaining program 321 compares whether the second hash data 16 is equal to the first hash data 14; if yes, performing to Step S715, the data chaining program 321 determines that the specific data 12 is an original data that does not tampered with; if not, performing to step S716, the data chaining program 321 determines that the specific data 12 is a data that has been tampered with.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A system capable of uploading data into a blockchain, the system comprising:
a data storage device comprising:
a data transmission interface;
a controller; and
a plurality of flash memories, wherein the controller is connected to the data transmission interface and the flash memories, and calculates a specific data to be stored to the flash memories or the specific data stored in the flash memories by a hash algorithm to obtain a first hash data corresponding to the specific data; and
an electronic device, comprising:
a processor; and
a network communication component, wherein the processor is connected to the network communication component, the electronic device is network connected to a blockchain via the network communication component;
wherein the data storage device transmits the first hash data to the electronic device via the data transmission interface; when the electronic device receives the first hash data, the processor of the electronic device executes a data chaining program, and uploads the first hashed data to the blockchain by the data chaining program so as to chain the first hash data into the blockchain.

2. The system according to claim 1, wherein the flash memories are formed with a first data storage area and a second data storage area, the first data storage area is used for storing general data, the second data storage area is used for storing the specific data.

3. The system according to claim 1, wherein the specific data is a data in a specific file format, or a data with a specific content.

4. The system according to claim 1, wherein the controller comprises a firmware, and the data chaining program is disposed in the firmware.

5. The system according to claim 1, wherein the processor is configured with an embedded system, and the data chaining program is installed in the embedded system.

6. The system according to claim 1, wherein the electronic device receives the specific data from the data storage device, and uploads the specific data to the blockchain by the data chaining program so as to chain the specific data into the blockchain.

7. The system according to claim 1, wherein the data transmission interface is SATA transmission interface, PCIe transmission interface, or USB transmission interface.

8. A method capable of uploading data into a blockchain, which is adapted to a data chaining system, wherein the data chaining system comprises a data storage device and an electronic device; the data storage device comprises a controller, a plurality of flash memories, and a data transmission interface; the electronic device comprises a processor and a network communication component; the data storage device and the electronic device are connected together via the data transmission interface, and the electronic device is network connected to a blockchain via the network communication component, the method comprising:
calculating a specific data to be stored to the flash memories or the specific data stored in the flash memories by a hash algorithm executed by the controller of the data storage device to obtain a first hash data;
transmitting the first hash data to the electronic device via the data transmission interface of the data storage device; and
executing a data chaining program by the microprocessor of the data storage device to upload the first hash data to the blockchain and chain the first hash data into the blockchain.

9. The method according to claim 8, further comprising:
uploading the specific data to the blockchain by the data chaining program to chain the specific data into the blockchain.

10. The method according to claim 8, further comprising a data authenticity verification procedure comprising:
calculating the specific data in the flash memories again by the hash algorithm executed by the controller of the data storage device to obtain a second hash data;
transmitting the second hash data to the electronic device by the data transmission interface of the data storage device;
downloading the first hash data corresponding to the specific data from the blockchain by the processor of the electronic device via the network communication component; and
comparing whether the second hash data is equal to the first hash data to determine whether the specific data is tampered with.
